(19) United States
(12) Patent Application Publication
(10) Pub. No.: US 2026/0336734 A1
(43) Pub. Date: Oct. 29, 2026

(54) Bike Carrier

(71) Applicant: Jeremy JANECZKO, Woodland Hills, CA (US)

(72) Inventor: Jeremy JANECZKO, Woodland Hills, CA (US)

(21) Appl. No.: 19/117,604

(22) PCT Filed: Feb. 17, 2023
(86) PCT No.: PCT/US2023/013342

§ 371 Date: Apr. 1, 2025

Related U.S. Application Data
(60) Provisional application No. 63/436,560, filed on Dec. 31, 2022.

(51) Int. Cl. B62H 3/00

(52) U.S. Cl. CPC B62H 3/00

(57) ABSTRACT

A bicycle carrier for transporting a bicycle inside a vehicle is disclosed. The bicycle carrier includes a platform having a first end and a second end, a first side and a second side. The bicycle carrier includes a skewer mount extending from the surface of the platform at the first end. The skewer mount includes a channel for receiving a skewer. The bicycle carrier includes a first strap connected to the first side of the platform. The bicycle carrier includes a second strap connected to the second side of the platform. The platform positions over a seat in a vehicle facing the second end. The second strap wraps around the seat and connects to the first strap. The skewer draws through the channel and receives a fork of a bicycle. The skewer mount includes cover sections positioned over the channel.

### CROSS-REFERENCE TO RELATED APPLICATIONS

This Application is a National Phase § 371 application of PCT Application No. PCT/US2023/013342, filed on Feb. 17, 2023, entitled “Bike Carrier,” which claims priority to and benefit of U.S. Provisional Patent Application No. 63/436,560 to Janeczko, entitled, “Bike Carrier,” filed Dec. 31, 2022, the contents of each are incorporated by reference.

### FIELD OF THE DISCLOSURE

The present invention relates to bicycles, and more specifically, to a bicycle carrier that is easily attached and then detached from a folded down rear of a seat in a vehicle.

### BACKGROUND OF THE INVENTION

With the growing popularity of bicycling as a recreational activity, various systems are designed for mounting and carrying bicycles on vehicles. Some of the systems include, but not limited to, bike racks, bicycle carriers (or bike carriers), etc. The bike racks currently available are generally not adaptable to all four wheeled vehicles. Most of the bicycle carriers are cumbersome and can neither be stored nor carried easily by the biker. Further, the bicycle carriers are difficult to install and may cause damage to the vehicles. Different design considerations are involved from the bicycle carriers because of the substantial weight of bicycles, handling difficulty of bicycles, and the cost involved in creating a quality bike carrier.

Some devices carry the bicycles on the top of the vehicle. In such case of roof rack style bike mounts, the bike on the top of the vehicle creates wind drag on the vehicle during transport. Moreover, it requires great effort to lift the bike up to the vehicle roof and take it down. There is also the danger that the bicycles on roof racks may not fit into garages or other areas of low clearance. Additional carriers for enabling the bicycles to be carried at the front or rear end of the vehicles are also known in the prior art. For example, the rear bumper mounted carrier has been popular because of its smaller size and low lift height. Many current carriers require permanent fixation to the vehicle, or if not permanently fixed, require great time and effort to attach or detach the carrier from the car.

Several bicycle carriers or racks have been disclosed in the past. One such example is disclosed in a PCT Publication No. WO/2017/155382, entitled “Configurable carrier for transporting bicycles inside a vehicle” (“the '382 Publication”) to Bizcarguenaga Ansola. The '382 Publication discloses a configurable carrier for a bicycle, which allows bicycles to be transported inside a motor vehicle. The versatile design thereof allows it to be assembled in different configurations that facilitate the adaptation thereof to the back of the seat of any vehicle without compromising on safety during the transport of the bicycles.

Another example is disclosed in a United States Publication No. 20140367437, entitled “Bicycle vehicle interior mounting system” (“the '437 Publication”) to D'Angelo. The '437 Publication discloses a bicycle mounting system having a base board with a flat top, a threaded aperture, and an alignment feature. A removable fork mount includes a first lug extending from a first side, a second lug extending from a second side and a threaded fastener for removably attaching the fork mount to the base board. The threaded fastener has a knob to enable attaching and removing the fork mount without tools. A contact fastener on the base board attaches the system to a vehicle to make this a somewhat permanent fixture in the vehicle.

Yet another example is disclosed in a United States Publication No. 20070119887, entitled “Bicycle carrier” (“the '887 Publication”) to Foley. The '887 Publication discloses a bicycle carrier, including a rack and a fork mount. The rack includes cross bars for mounting on a vehicle. The fork mount includes a head portion adapted to selectively clamp the fork mount to one of the cross bars, and a skewer assembly adapted to selectively secure forks of a bicycle to the head portion. The skewer assembly includes a skewer bolt, an actuator handle that is moveable between a first position and a second position, and an adjustment member threaded onto an end of the skewer bolt that permits longitudinal adjustment of the skewer assembly to accommodate different fork dimensions. The adjustment member is accessible when the actuator handle is in the first position, but is covered by the actuator handle when the actuator handle is in the second position.

Many of the above discussed bike carriers are rear mounted external mounts, which leaves the bicycles exposed to collision; theft and the possibility of dropping off of the vehicle. The rear mounted carriers require the use of retaining ropes and straps for securing bicycles to the carriers. The use of the retaining ropes and straps has caused the reliability of the bicycle mountings to depend to some extent on the skill and care of the user. It is important for a rack to permit the bike to be locked on to prevent unauthorized removal.

Another example is disclosed in a United States Publication No. 20090266773, entitled “Portable bike carrier” (“the '773 Publication”) to Janeczko. The '773 Publication attempts to solve some of these problems discussed above. The '773 Publication discloses a portable bike carrying device for transportation of bikes inside a vehicle. The device includes a scalloped platform, a metal casted skewer mount containing a quick release bolt, nuts and washers and Velcro hook to insure grip to vehicle carpet. The bike carrier is equipped on the back of the vehicle by folding down the seat. The bike is mounted on the platform in an upright position and the fork (shown as a front fork) of the bicycle is attached to the skewer mount and tightened down for securing the bike during travel. The paddle design includes a handle for easily and quickly removing and storing the carrier. The platform may have various shapes and sizes such as paddle, disc or other shapes and is manufactured of wood and/or plastic.

Still, there remains a continuing need for improved bike carriers and mounts.

### BRIEF SUMMARY OF THE PRESENT INVENTION

The present invention includes embodiments for a bicycle carrier that is releasably secured to a seat for connecting a fork of a bicycle.

The present invention provides a bicycle carrier for transporting a bicycle inside a vehicle. The bicycle carrier includes a platform having a first end and a second end, a first side and a second side. The first end indicates a top end and the second end indicates a bottom end of the platform. The bicycle carrier includes a skewer mount extending from the surface of the platform at the first end. The skewer mount includes a channel for receiving a skewer. The bicycle carrier includes a first strap connected to the first side of the platform. The bicycle carrier includes a second strap connected to the second side of the platform. The platform positions over a seat in a vehicle facing the second end. The second strap wraps around the seat and the second strap connects to the first strap. The skewer draws through the channel and receives a fork of a bicycle.

Further, the skewer mount includes one or more cover sections. The one or more cover sections position over the channel. The one or more cover sections prevent the skewer from being lifted out of the channel.

In one aspect of the present invention, the first strap connects to the second strap via a connecting member such as a buckle, for example.

In another aspect of the present invention, the skewer includes an elongated rod having a lever at one end and an end cap at another end. The elongated rod draws through the channel. Here, the lever operates to tighten the skewer to secure the fork to the skewer mount. Further, the elongated rod includes one or more spring members. The one or more spring members position along the length of the elongated rod and allow to tighten the skewer.

In one advantageous feature of the present invention, the bicycle carrier mounts to the seat when the seat is in a folded configuration. The bicycle carrier aids in transporting the bicycle inside the vehicle temporarily without any permanent installation of any parts needed. This eliminates the need for a bike rack, and does not require a user to lift the bicycle high above one's head to put it on the rack. Additionally, the bicycle carrier protects the bicycle, as the bicycle is secured within the vehicle and without being exposed, which reduces risk of being stolen. By having the bicycle in the car, the vehicle's security system also acts as a bicycle's security system.

In another aspect, the techniques described herein relate to a method of providing a bicycle carrier, the method including steps of: providing a platform having a first end and a second end, a first side and a second side, the first end indicating a top end and the second end indicating a bottom end of the platform; providing a skewer mount extending from a surface of the platform at the first end; providing a channel in the skewer mount for receiving a skewer; providing one or more cover sections at the skewer mount, the one or more cover sections positioning over the channel; providing a first strap connected to the first side of the platform; providing a second strap connected to the second side of the platform; positioning the platform over a seat in a vehicle facing the second end; wrapping the second strap around the seat and connecting the second strap to the first strap; and, drawing the skewer through the channel and receiving a fork of a bicycle such that the one or more cover sections prevent the skewer from being lifted out of the channel.

Features and advantages of the subject matter hereof will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

With the above and other related objects in view, the subject matter consists in the details of construction and combination of parts as will be more fully understood from the following description, when read in conjunction with the accompanying drawings in which:

FIG. 1 illustrates an environment in which a bicycle carrier is installed at a seat within a vehicle for connecting a bicycle, in accordance with one embodiment of the present invention;

FIG. 2a and FIG. 2b illustrate a top perspective view and a bottom perspective view, respectively of the bicycle carrier, in accordance with one embodiment of the present invention;

FIG. 3 illustrates a perspective view of a platform, in accordance with one embodiment of the present invention;

FIG. 4 illustrates a perspective view of a skewer, in accordance with one embodiment of the present invention;

FIG. 5 illustrates an enlarged view of the platform receiving the skewer, in accordance with one embodiment of the present invention;

FIG. 6 illustrates a side perspective view of the bicycle carrier removably secured to the seat, in accordance with one embodiment of the present invention;

FIG. 7, FIG. 8 and FIG. 9 illustrate the feature of connecting a front fork of the bicycle to the bicycle carrier, in accordance with one embodiment of the present invention; and

FIG. 10 illustrates the feature of securing the bicycle carrier to the seat at the center of the back seat/row in the vehicle and connecting the bicycle, in accordance with another embodiment of the present invention.

### DETAILED DESCRIPTION OF EMBODIMENTS

The invention now will be described more fully hereinafter with reference to the accompanying drawings, in which embodiments of the invention are shown. This invention may however be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section.

It will be understood that the elements, components, regions, layers and sections depicted in the figures are not necessarily drawn to scale.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” “upper” or “top,” “left” or “right,” “above” or “below,” “front” or “rear,” may be used herein to describe one element's relationship to another element as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. The numbers, ratios, percentages, and other values may include those that are ±5%, ±10%, ±25%, ±50%, ±75%, ±100%, ±200%, ±500%, or other ranges that do not detract from the spirit of the invention. The terms about, approximately, or substantially may include values known to those having ordinary skill in the art. If not known in the art, these terms may be considered to be in the range of up to ±5%, ±10%, or other value higher than these ranges commonly accepted by those having ordinary skill in the art for the variable disclosed. Thus, embodiments of the present invention should not be construed as limited to the particular shapes of regions illustrated herein but are to include deviations in shapes that result, for example, from manufacturing. The invention illustratively disclosed herein suitably may be practiced in the absence of any elements that are not specifically disclosed herein. All patents, patent applications and non-patent literature cited through this application are hereby incorporated by reference in their entireties.

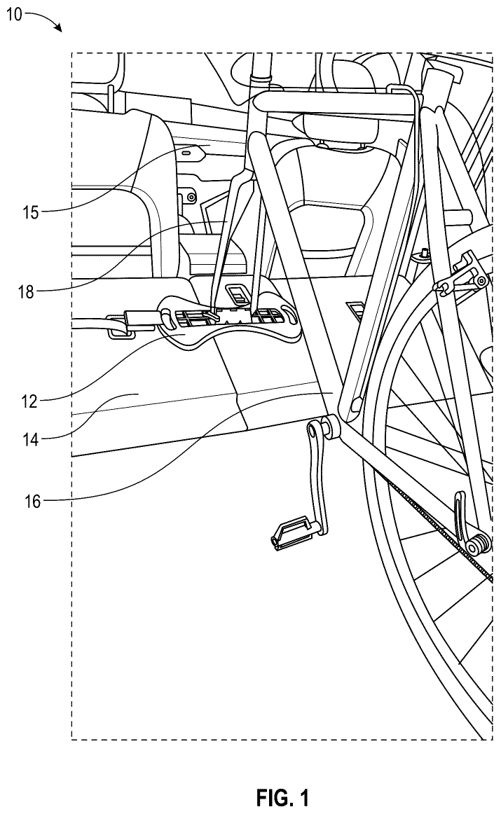

Turning to the Figures, FIG. 1 shows an environment 10 in which a bicycle carrier 12 is installed at the back of a seat 14 (in folded configuration) within a vehicle 15 for connecting a bicycle 16, in accordance with one exemplary embodiment of the present invention. Bicycle carrier 12 is also referred to as a carrier or a bike carrier or a bicycle-gripping carrier or a bicycle mount. Vehicle 15 includes, but not limited to, a car, truck, boat or any other vehicle used for transportation. Bicycle 16 can also be referred to as a bike or a recreational equipment. As can be seen from FIG. 1, bicycle carrier 12 mounts to seat 14 when seat 14 is in folded configuration. Here, bicycle 16 is releasably secured to bicycle carrier 12 via a fork 18 of bicycle 16. A person skilled in the art understands that the front fork or rear fork of bicycle 16 can be connected to bicycle carrier 12 without departing from the scope of the present invention.

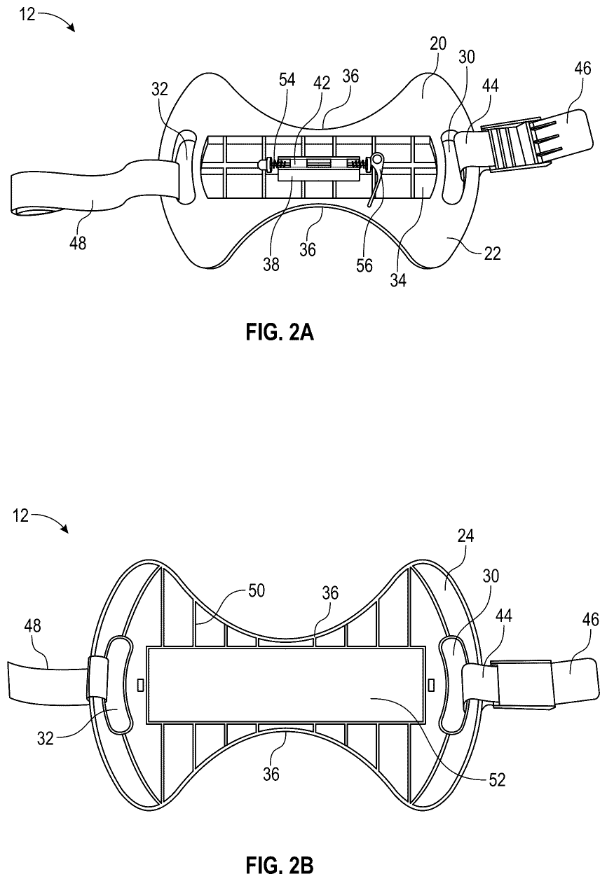

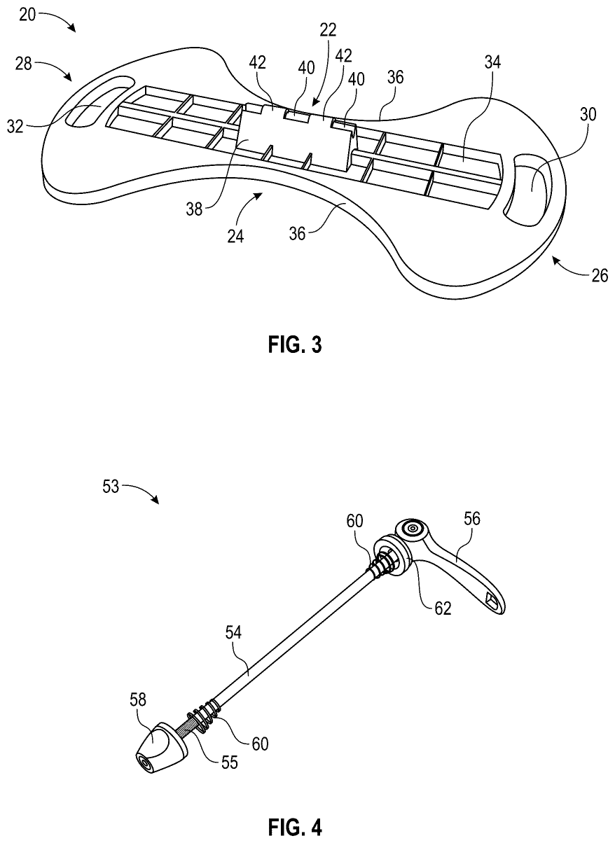

FIG. 2A and FIG. 2B show a top perspective view and a bottom perspective view, respectively of bicycle carrier 12, in accordance with one embodiment of the present invention. Bicycle carrier 12 includes a platform or plate 20. Platform 20 is made of metal, hard plastic, wood, or any other suitable material. In one example, platform 20 comes in a scalloped, or bow-tied configuration. In another example, platform 20 comes in a square, rectangular or any other configuration without departing from the scope of the present invention. FIG. 3 shows a perspective view of platform 20, in accordance with one embodiment of the present invention. Platform 20 has a first end 22 and a second end 24. First end 22 indicates a top end of platform 20. Second end 24 indicates a bottom end of platform 20. Further, platform 20 has a first side 26 and a second side 28. First side 26 indicates a left side and second side 28 indicates a right side, or vice versa of platform 20. Platform 20 includes a first strap section 30 at first side 26. Further, platform 20 includes a second strap section 32 at second side 28. As can be seen, first strap section 30 and second strap section 32 are provided at distal ends of platform 20. Here, each of first strap section 30 and second strap section 32 acts as a handle for platform 20 at each side. First strap section 30 and second strap section 32 allow a user (not shown) to hold platform 20 with one or both hands while installing or uninstalling platform 20 from seat 14.

In one embodiment, platform 20 includes a plurality of recesses or cut-away sections 34. Optionally, platform 20 is provided to have a flat surface. Further, platform 20 includes curved sections 36 at adjacent (i.e., approximately perpendicularly) to first side 26 and second side 28. Curved sections 36 form a concave shape at platform 20. Curved sections 36 presents the platform 20 to have scalloped, or bow-tied configuration.

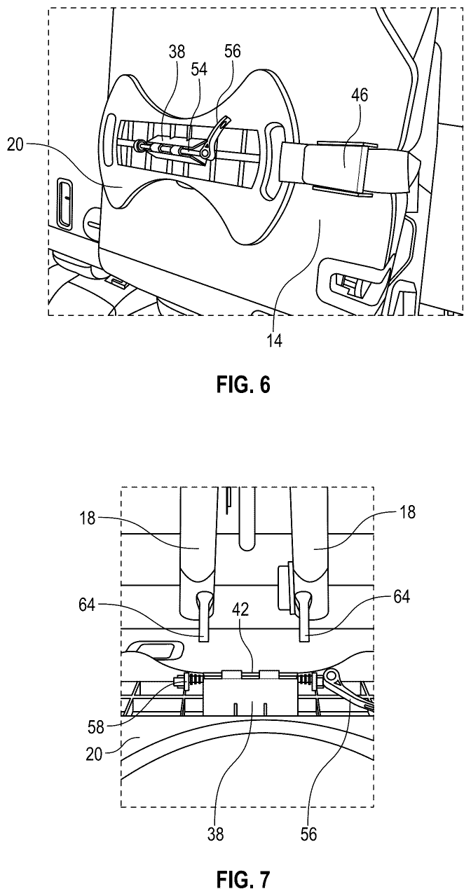

Further, platform 20 includes a skewer mount 38. Skewer mount 38 extends from the surface of platform 20 in the direction of first end 22. In other words, skewer mount 38 extends/elevates from the center of platform 20 at first end 22. In one embodiment, skewer mount 38 is tapered in that the end of skewer mount 38 connecting platform 20 is thicker and skewer mount 38 tapers down as it extends from the surface of platform 20. At the top, skewer mount 38 includes a skewer receiving section or channel 40. Here, channel 40 indicates an opening formed along the length of skewer mount 38 at the top. Further, skewer mount 38 includes one or more cover sections or channel top covers 42. Cover sections 42 position over channel 40 at a distance from one another. Optionally, only one cover sections 42 is provided extending along the entire or partial length of skewer mount 38. Cover sections 42 close the open gap (or opening) formed by channel 40 with skewer mount 38 at the top. In other words, cover sections 42 are provided at the top to prevent an elongated rod 54 from being lifted out of channel 40 or skewer mount 38 (as shown in FIG. 6, for example).

Referring to FIG. 2A and FIG. 2B, bicycle carrier 12 includes a first strap 44. First strap 44 draws through first strap section 30. In one embodiment, first strap 44 encompasses a connecting member 46. Connecting member 46 includes a buckle or any other similar mechanism. Further, bicycle carrier 12 includes a second strap 48. Second strap 48 draws through second strap section 32. Second strap 48 extends and connects to first strap 44 via connecting member 46. Further, platform 20 includes a plurality of ribs 50 at second end 24, as shown in FIG. 2B. Ribs 50 provide rigidity and support to platform 20. Further, platform 20 includes a support base 52. In one example, support base 52 comes in a flat configuration. In example, support base 52 is provided with an adhesive surface. In another example, support base 52 is provided with hook and loops (similar to Velcro™) to connect platform 20 to seat 14.

In one embodiment, bicycle carrier 12 includes a quick-release skewer or simply skewer 53. FIG. 4 shows a perspective view of skewer 53, in accordance with one embodiment of the present invention. Skewer 53 includes an elongated rod 54. Elongated rod 54 is made of metal, hard plastic, wood or any other suitable material. Elongated rod 54 includes a threaded portion 55 at one end. At the other end, elongated rod 54 includes a lever 56. Skewer 53 includes an end cap 58. End cap 58 indicates an adjustable nut having an opening (not shown) for receiving threaded portion 55. Further, skewer 53 includes one or more spring members 60. Spring members 60 come in conical or tapered configuration in that the larger diameter side of respective spring members 60 faces lever 56 and end cap 58. Spring members 60 are tapered such that spring members 60 can easily move/slide within channel 40 during operation. Further, skewer 53 includes a support member 62 positioned between spring member 60 and lever 56. Support member 62 acts as an intermediary component between spring member 60 and lever 56, and supports lever 56. In one example, support member 62 includes a washer.

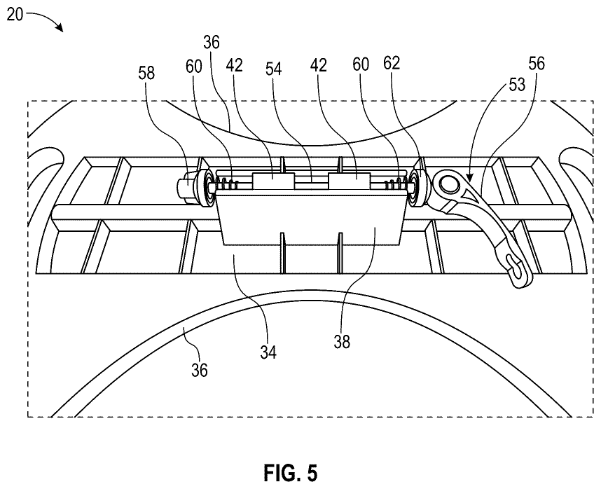

Now referring to FIG. 5, an enlarged view of platform 20 receiving skewer 53 is shown, in accordance with one embodiment of the present invention. At first, elongated rod 54 is drawn through channel 40. As can be seen, one spring member 60 is positioned in proximity to threaded portion 55 and cover section 42; and another spring member 60 is poisoned in between support member 62 and cover section 42. After drawing elongated rod 54, end cap 58 is secured to elongated rod 54 via threaded portion 55.

FIG. 6 shows a side perspective view of bicycle carrier 12 removably secured to seat 14. In order to secure bicycle carrier 12 to seat 14, at first, the back seat 14 of vehicle 15 is folded down. Subsequently, bicycle carrier 12 is placed over seat 14. Specifically, support base 52 is placed over seat 14 and top end 22 of platform 20 is exposed. Further, the length of second strap 48 is adjusted and wrapped around seat 14 to connect to first strap 44 via connecting member 46.

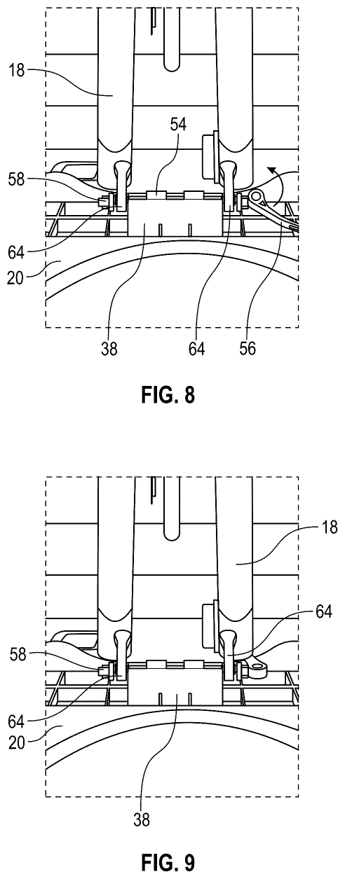

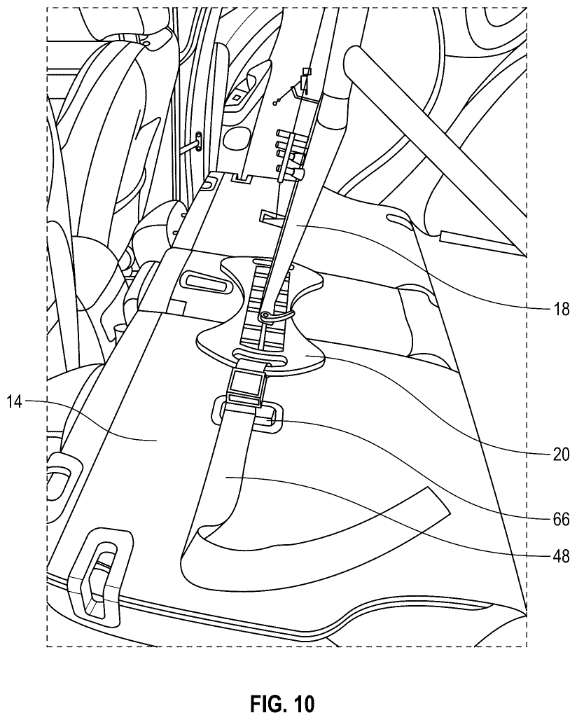

After securing bicycle carrier 12 to seat 14, front fork 18 (or rear fork) is aligned with elongated rod 54 of skewer 53, as shown in FIG. 7. As can be seen, front fork 18 includes hook-like structures or drop outs 64 at the distal end. Typically, hook-like structures 64 are used to connect front fork 18 to a hub (not shown) of bicycle 16. Here, hook-like structures 64 are secured to elongated rod 54. In one example, hook-like structures 64 are positioned at distal ends of skewer mount 38, as shown in FIG. 8. After positioning, lever 56 is pushed to secure/lock hook-like structures 64 to skewer 53. FIG. 9 shows the feature of lever 56 in engaged configuration, tightly securing front fork 18 to bicycle carrier 12 via skewer 53.

Although the present invention describes skewer 53 to be part of skewer mount 38, a person skilled in the art understands that it is possible to provide skewer 53 as a separate component that is releasably connected to skewer mount 38. Optionally, skewer 53 can come as a component integral with bicycle 18 to connect to the hub of bicycle 18. Such a skewer 53 is removed from bicycle 18 and is used to connect front fork 18 to bicycle carrier 12.

FIG. 10 shows the feature of securing bicycle carrier 12 to seat 14 at the center of the back seat/row in vehicle 15 and connecting bicycle 16, in accordance with one exemplary embodiment of the present invention. Here, second strap 48 draws through a seat connector 64 positioned at the back of seat 14. A person skilled in the art understands that bicycle carrier 12 can be connected to seat 14 in a variety of ways without departing from the scope of the present invention.

In accordance with the present invention, bicycle carrier 12 connects to (rear) seat 14 upon folding down. This ensures the front fork 18 is placed over seat 14 and there is enough space on the remainder of bicycle 16 to position within vehicle 15, as shown in FIG. 1, for example.

In order to uninstall bicycle 16, the user disengages lever 56. Subsequently, the user removes front fork 18 from skewer 53. Subsequently, the user uninstalls second strap 48 from first strap 44 via connecting member 46. Further, the user holds first strap section 30 and/or second strap section 32 to remove bicycle carrier 12 from seat 14. Furthermore, the user positions seat 14 in an upright/normal position for allowing passengers to be seated.

The embodiments provide for several advantages over the prior art. For example, the presently disclosed bicycle carrier is easy to install and uninstall from the seat. The seat can be connected to a folded seat of the vehicle via straps. Further, the bicycle carrier includes a skewer mount which allows the skewer to draw through easily and receives the front fork of the bicycle. This allows the bicycle to be placed in an upright position in the vehicle and provides more space within the vehicle. When not needed, the bicycle can be removed easily from the skewer using the lever and the bicycle carrier can be removed by uninstalling the straps. The seat can be put back in the upright position for using the seat normally. In addition, when the bicycle carrier is not in use, it can be easily stored, unlike convention roof rack systems. Yet another advantage is that if the user already has two bicycle racks on the vehicle (such as on the roof or the bumper), the present device will allow the user to add a third bicycle for carrying.

Clause 1. A bicycle carrier, comprising: a) a platform having a first end and a second end, a first side and a second side, and wherein the first end indicates a top end and the second end indicates a bottom end of the platform; b) a skewer mount extending from a surface of the platform at the first end, wherein the skewer mount comprises a channel for receiving a skewer; c) a first strap connected to the first side of the platform; and, d) a second strap connected to the second side of the platform, whereby the platform is designed to be positioned over a seat in a vehicle facing the second end, whereby the second strap wraps around the seat and connects to the first strap, and, whereby the skewer is designed to be drawn through the channel and is capable of receiving a fork of a bicycle.

Clause 2. The bicycle carrier of clause 1, wherein the skewer mount comprises one or more cover sections, wherein the one or more cover sections position over the channel, and wherein the one or more cover sections prevent the skewer from being lifted out of the channel.

Clause 3. The bicycle carrier of clause 1, wherein the first strap connects to the second strap via a connecting member.

Clause 4. The bicycle carrier of clause 3, wherein the connecting member is a buckle.

Clause 5. The bicycle carrier of clause 1, wherein the skewer comprises an elongated rod having a lever at one end and an end cap at another end.

Clause 6. The bicycle carrier of clause 5, wherein the elongated rod draws through the channel, and wherein the lever operates to tighten the skewer to secure the fork to the skewer mount.

Clause 7. The bicycle carrier of clause 6, wherein the elongated rod comprises one or more spring members, wherein the one or more spring members position along a length of the elongated rod, and wherein the one or more spring members allow to tighten the skewer.

Clause 8. The bicycle carrier of clause 7, wherein the one or more spring members come in conical configuration.

Clause 9. The bicycle carrier of clause 1, wherein the platform comprises a first strap section at the first side for securing the first strap.

Clause 10. The bicycle carrier of clause 1, wherein the platform comprises a second strap section at the second side for securing the second strap.

Clause 11. The bicycle carrier of clause 1, wherein the skewer mount is tapered.

Clause 12. A bicycle carrier, comprising: a platform having a first end and a second end, a first side and a second side, and wherein the first end indicates a top end and the second end indicates a bottom end of the platform; a skewer mount extending from a surface of the platform at the first end, wherein the skewer mount has a channel for receiving a skewer, wherein the skewer mount comprises one or more cover sections, and wherein the one or more cover sections position over the channel; a first strap connected to the first side of the platform; and, a second strap connected to the second side of the platform, whereby the platform is designed to be positioned over a seat in a vehicle facing the second end, whereby the second strap wraps around the seat and connects to the first strap, and, whereby the skewer is designed to be drawn through the channel and is capable of receiving a fork of a bicycle.

Clause 13. The bicycle carrier of clause 12, wherein the first strap connects to the second strap via a connecting member, and wherein the connecting member is a buckle.

Clause 14. The bicycle carrier of clause 12, wherein the skewer comprises an elongated rod having a lever at one end and an end cap at another end.

Clause 15. The bicycle carrier of clause 14, wherein the elongated rod draws through the channel, and wherein the lever operates to tighten the skewer to secure the fork to the skewer mount.

Clause 16. The bicycle carrier of clause 15, wherein the elongated rod comprises one or more spring members, wherein the one or more spring members position along a length of the elongated rod, and wherein the one or more spring members allow to tighten the skewer.

Clause 17. The bicycle carrier of clause 16, wherein the one or more spring members come in conical configuration.

Clause 18. The bicycle carrier of clause 12, wherein the platform comprises a first strap section at the first side for securing the first strap, and wherein the platform comprises a second strap section at the second side for securing the second strap.

Clause 19. A method of providing a bicycle carrier, the method comprising steps of: providing a platform having a first end and a second end, a first side and a second side, the first end indicating a top end and the second end indicating a bottom end of the platform; providing a skewer mount extending from a surface of the platform at the first end; providing a channel in the skewer mount for receiving a skewer; providing one or more cover sections at the skewer mount, the one or more cover sections positioning over the channel; providing a first strap connected to the first side of the platform; providing a second strap connected to the second side of the platform; positioning the platform over a seat in a vehicle facing the second end; wrapping the second strap around the seat and connecting the second strap to the first strap; and, drawing the skewer through the channel and receiving a fork of a bicycle such that the one or more cover sections prevent the skewer from being lifted out of the channel.

Clause 20. The method of clause 19, further comprising providing a lever at the skewer for tightening the skewer to secure the front fork to the skewer mount.

While the invention has been described in terms of exemplary embodiments, it is to be understood that the words that have been used are words of description and not of limitation. As is understood by persons of ordinary skill in the art, a variety of modifications can be made without departing from the scope of the invention defined by the following claims, which should be given their fullest, fair scope.

What is claimed is:

1. A bicycle carrier (12), comprising:
a) a platform (20) having a first end (22) and a second end (24), a first side (26) and a second side (28), and wherein the first end (22) indicates a top end and the second end (24) indicates a bottom end of the platform (20);
b) a skewer mount (38) extending from a surface of the platform (20) at the first end (22), wherein the skewer (53) mount (38) comprises a channel (40) for receiving a skewer (53);
c) a first strap (44) connected to the first side (26) of the platform (20); and,
d) a second strap (48) connected to the second side (28) of the platform (20),
whereby the platform (20) is designed to be positioned over a seat (14) in a vehicle (15) facing the second end (24), whereby the second strap (48) wraps around the seat (14) and connects to the first strap and,
whereby the skewer (53) is designed to be drawn through the channel (40) and is capable of receiving a fork (18) of a bicycle (16).

2. The bicycle (16) carrier (12) of claim 1, wherein the skewer mount (38) comprises one or more cover sections (42), wherein the one or more cover sections (42) position over the channel (40), and wherein the one or more cover sections (42) prevent the skewer (53) from being lifted out of the channel (40).

3. The bicycle carrier (12) of claim 1, wherein the first strap connects to the second strap (48) via a connecting member (46).

4. The bicycle carrier (12) of claim 3, wherein the connecting member (46) is a buckle.

5. The bicycle carrier (12) of claim 1, wherein the skewer (53) comprises an elongated rod (54) having a lever (56) at one end and an end cap (58) at another end.

6. The bicycle carrier (12) of claim 5, wherein the elongated rod (54) draws through the channel (40), and wherein the lever (56) operates to tighten the skewer (53) to secure the fork (18) to the skewer mount (38).

7. The bicycle carrier (12) of claim 6, wherein the elongated rod (54) comprises one or more spring members (60), wherein the one or more spring members (60) position along a length of the elongated rod (54), and wherein the one or more spring members (60) allow to tighten the skewer (53).

8. The bicycle carrier (12) of claim 7, wherein the one or more spring members (60) come in conical configuration.

9. The bicycle carrier (12) of claim 1, wherein the platform (20) comprises a first strap (44) section (30) at the first side (26) for securing the first strap (44).

10. The bicycle carrier (12) of claim 1, wherein the platform (20) comprises a second strap (48) section (32) at the second side (28) for securing the second strap (48).

11. The bicycle carrier (12) of claim 1, wherein the skewer (53) mount (38) is tapered.

12. A bicycle carrier (12), comprising:
a) a platform (20) having a first end (22) and a second end (24), a first side (26) and a second side (28), and wherein the first end (22) indicates a top end and the second end (24) indicates a bottom end of the platform (20);
b) a skewer mount (38) extending from a surface of the platform (20) at the first end (22), wherein the skewer (53) mount (38) has a channel (40) for receiving a skewer (53), wherein the skewer mount (38) comprises one or more cover sections and wherein the one or more cover sections (42) position over the channel (40);
c) a first strap (44) connected to the first side (26) of the platform (20); and,
d) a second strap (48) connected to the second side (28) of the platform (20),
whereby the platform (20) is designed to be positioned over a seat (14) in a vehicle (15) facing the second end (24), whereby the second strap (48) wraps around the seat (14) and connects to the first strap (44), and,
whereby the skewer (53) is designed to be drawn through the channel (40) and is capable of receiving a fork (18) of a bicycle (16).

13. The bicycle carrier (12) of claim 12, wherein the first strap (44) connects to the second strap (48) via a connecting member (46), and wherein the connecting member (46) is a buckle.

14. The bicycle carrier (12) of claim 12, wherein the skewer (53) comprises an elongated rod (54) having a lever (56) at one end and an end cap (58) at another end.

15. The bicycle carrier (12) of claim 14, wherein the elongated rod (54) draws through the channel (40), and wherein the lever (56) operates to tighten the skewer (53) to secure the fork (18) to the skewer mount (38).

16. The bicycle (16) carrier (12) of claim 15, wherein the elongated rod (54) comprises one or more spring members (60), wherein the one or more spring members (60) position along a length of the elongated rod (54), and wherein the one or more spring members (60) allow to tighten the skewer (53).

17. The bicycle carrier (12) of claim 16, wherein the one or more spring members (60) come in conical configuration.

18. The bicycle carrier (12) of claim 12, wherein the platform (20) comprises a first strap (44) section (30) at the first side (26) for securing the first strap (44), and wherein the platform (20) comprises a second strap (48) section (32) at the second side (28) for securing the second strap (48).

19. A method of providing a bicycle carrier (12), the method comprising steps of:
providing a platform (20) having a first end (22) and a second end (24), a first side (26) and a second side (28), the first end (22) indicating a top end and the second end (24) indicating a bottom end of the platform (20);
providing a skewer mount (38) extending from a surface of the platform (20) at the first end (22);
providing a channel (40) in the skewer (53) mount (38) for receiving a skewer (53);
providing one or more cover sections at the skewer mount (38), the one or more cover sections (42) positioning over the channel (40);
providing a first strap (44) connected to the first side (26) of the platform (20);
providing a second strap (48) connected to the second side (28) of the platform (20);
positioning the platform (20) over a seat (14) in a vehicle (15) facing the second end (24);
wrapping the second strap (48) around the seat (14) and connecting the second strap (48) to the first strap (44); and,
drawing the skewer (53) through the channel (40) and receiving a fork of a bicycle (16) such that the one or more cover sections (42) prevent the skewer (53) from being lifted out of the channel (40).

20. The method of claim 19, further comprising providing a lever (56) at the skewer (53) for tightening the skewer (53) to secure the fork (18) to the skewer mount (38).
